(19) United States
(12) Patent Application Publication
(10) Pub. No.: US 2017/0168205 A1
(43) Pub. Date: Jun. 15, 2017

(54) WIDEBAND COMPOUND PHASE-RETARDATION FILM AND WIDEBAND CIRCULAR POLARIZER USING THE SAME

(71) Applicant: INDUSTRIAL TECHNOLOGY RESEARCH INSTITUTE, Hsinchu (TW)

(72) Inventors: Pao-Ju HSIEH, Hsinchu County (TW); Chi-Fu TSENG, Taipei City (TW); Yi-Chang DU, Miaoli County (TW); Mei-Chih PENG, Taoyuan City (TW)

(73) Assignee: INDUSTRIAL TECHNOLOGY RESEARCH INSTITUTE, Hsinchu (TW)

(21) Appl. No.: 14/985,696

(22) Filed: Dec. 31, 2015

(30) Foreign Application Priority Data
Dec. 9, 2015 (TW) 104141352

(51) Int. Cl. G02B 5/30; G02B 27/28

(52) U.S. Cl. CPC G02B 5/3016; G02B 27/286

(57) ABSTRACT

A wideband compound phase-retardation film including a half-wave phase-retardation film and a quarter-wave phase-retardation film with different reactive rod-like liquid crystal combination is provided. The half-wave phase-retardation film uses material having a birefringence of Δn₁, and the quarter-wave phase-retardation film uses material having a birefringence of Δn₂. The birefringence Δn₁ is smaller than the birefringence Δn₂. Furthermore, the birefringence dispersion Δn₁(λ) is also smaller than Δn₂(λ).

This application claims the benefit of Taiwan application Serial No. 104141352, filed Dec. 9, 2015, the disclosure of which is incorporated by reference herein in its entirety.

### TECHNICAL FIELD

The disclosure relates in general to a wideband compound phase-retardation film and a wideband circular polarizer using the same.

### BACKGROUND

Active-matrix organic light-emitting diode (AMOLED) has self-luminous and wide color gamut characteristic and possesses light-weight, portable, not easy-broken, impact-resistant, and flexible properties, which can be considered as a domained wearable display. However, AMOLEDs suffer from the loss of legibility under a bright environment, which is due to a high reflection emitted from their metal electrode structures as the ambient light shining on AMOLEDs. It is general to use a circular polarizer to block the ambient light reflection for solving the problem mentioned above.

Therefore, it is eager to develop a fully visible-range coverage of circular polarizer.

### SUMMARY

In one embodiment, a wideband compound phase-retardation film including a half-wave phase-retardation film and a quarter-wave phase-retardation film is provided. The quarter-wave phase-retardation film is disposed on the half-wave phase-retardation film. The materials of the half-wave phase-retardation film and the quarter-wave phase-retardation film are adopted from different reactive rod-like liquid crystals (RLC) respectively, wherein the birefringence of the RLC, Δn₁, used in the half-wave phase-retardation film is smaller than the birefringence of the RLC, Δn₂, used in the quarter-wave phase-retardation film. Furthermore, the birefringence dispersion of the half-wave phase-retardation film, Δn₁(λ), is smaller than the birefringence dispersion of the quarter-wave phase-retardation film, Δn₂(λ).

In one embodiment, a wideband circular polarizer including a linear polarizer and a wideband compound phase-retardation film is provided. The wideband compound phase-retardation film including a half-wave phase-retardation film and a quarter-wave phase-retardation film is disposed on the linear polarizer. The quarter-wave phase-retardation film is disposed on the half-wave phase-retardation film. The materials of the half-wave phase-retardation film and the quarter-wave phase-retardation film are adopted from different reactive rod-like liquid crystals (RLC) respectively, wherein the birefringence of the RLC, Δn₁, used in the half-wave phase-retardation film is smaller than the birefringence of the RLC, Δn₂, used in the quarter-wave phase-retardation film. Furthermore, the birefringence dispersion of the half-wave phase-retardation film, Δn₁(λ), is smaller than the birefringence dispersion of the quarter-wave phase-retardation film, Δn₂(λ).

### BRIEF DESCRIPTION OF THE DRAWINGS

FIG. 1 shows all the retardation dispersion results of Example 1, Comparative Example 1, Comparative Example 2 and ideal wideband retardation dispersion value.

FIG. 2 shows all the retardation dispersion results of Example 1, a commercial wideband film and ideal wideband retardation dispersion.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The disclosure provides a wideband compound phase-retardation film including a half-wave phase-retardation film and a quarter-wave phase-retardation film. The disclosure also provides a wideband circular polarizer including a linear polarizer and a wideband compound phase-retardation film. When an incident light passes through the wideband circular polarizer from linear polarizer side, it will be converted into a circular polarized light. This incident circular polarized light can be transformed into the other type of reflected circular polarized light which is not allowed to be emitted from the wideband circular polarizer. That is, the wideband circular polarizer can block the ambient light reflection from any reflection surface.

In one embodiment, a wideband compound phase-retardation film includes a half-wave phase-retardation film and a quarter-wave phase-retardation film. In one embodiment, the half-wave phase-retardation film and the quarter-wave phase-retardation film can be combined at specified angles. In one embodiment, the half-wave phase-retardation film and the quarter-wave phase-retardation film are made of different reactive rod-like liquid crystals (RLC) respectively, and the birefringence of the RLC, Δn₁, used in the half-wave phase-retardation film is smaller than the birefringence of the RLC, Δn₂, used in the quarter-wave phase-retardation film.

In one embodiment, a difference between Δn₁ and Δn₂ may be larger than or equal to 0.02 (such as 0.02≦Δn₂−Δn₁, 0.02≦Δn₂−Δn₁≦0.2, or 0.02≦Δn₂−Δn₁≦0.5).

Here, the retardation dispersion of a phase-retardation film, Re(λ), is determined by the product of the birefringence and the thickness (see the following equation (1)). In equation (1), Δn represents the birefringence of the phase-retardation film, d represents the thickness of the phase-retardation film, and Δn(λ) complies with Cauchy's equation (see equation (2)), wherein A, B, C are material coefficients. Different materials have different coefficients A, B, and C.

$$\begin{matrix}Re ( λ ) = Δ n ( λ ) \times d & ( 1 ) \\ Δ n ( λ ) = A + \frac{B}{{λ}^{2}} + \frac{C}{{λ}^{4}} & ( 2 )\end{matrix}$$

In a comparative example, a phase-retardation film consisted of two different thicknesses phase-retardation films but same material shows wideband phase-retardation optics, but still with a significant shift from the ideal wideband retardation dispersion value.

In one embodiment, a wideband compound phase-retardation film includes a half-wave phase-retardation film and a quarter-wave phase-retardation film made of different reactive rod-like liquid crystals (RLC) respectively results to ideal wideband retardation dispersion value. In one embodiment, when a wideband compound phase-retardation films are further laminated with the linear polarizer at appropriate angle, a wideband circular polarizer can be provided. The conversion of visible light into circular polarization may be much fulfilled. When the wideband circular polarizers are attached on the object (such as AMOLED) which suffers from the unwilling reflection of environmental light, the interference light may be blocked more effectively.

In one embodiment, the birefringence (Δn₁) of the reactive rod-like liquid crystal used in the half-wave phase-retardation film (half-wave plate, HWP) is smaller than the birefringence (Δn₂) of the reactive rod-like liquid crystal used in the quarter-wave phase-retardation film (quarter-wave plate, QWP). That is, Δn₁<Δn₂. In one embodiment, the birefringence dispersion of the half-wave phase-retardation film, Δn₁(λ), is smaller than the birefringence dispersion of the quarter-wave phase-retardation film, Δn₂(λ).

In the wideband compound phase-retardation film according to the embodiments of the disclosure, the optical axis of the half-wave phase-retardation film is set in some appropriate angle differences with the optical axis of the quarter-wave phase-retardation film, such as from 15 to 70 degrees or from 30 to 60 degrees.

Further, the half-wave phase-retardation film may have a retardance in the range from 200 to 300 nm, such as from 240 to 290 nm at a specified wavelength of 550 nm; the quarter-wave phase-retardation film may have a retardance in the range from 80 to 160 nm, such as from 120 to 160 nm at a specified wavelength of 550 nm.

In one embodiment, phase-retardation films having different reactive rod-like liquid crystals are used to form the wideband compound phase-retardation film. The reactive rod-like liquid crystals may be nematic crystals having an acrylate group, for example, LC242 of BASF chemical company (birefringence Δn₁=0.147 at wavelength of 589 nm)(4-[[[4-[(1-Oxo-2-propenyl)oxy]butoxy]carbonyl]oxy]benzoic acid 2-methyl-1,4-phenylene ester), which would be called as LC₁ hereinafter, and LC1057 of BASF chemical company (birefringence Δn₂=0.203 at wavelength of 589 nm)(6-[[[4-[(1-Oxo-2-propenyl)oxy]butoxy]carbonyl]oxy]-2-naphthalenecarboxylic Acid-2-(methoxycarbonyl)-1,4-phenylene Ester), which would be called as LC₂ hereinafter.

However, the disclosure is not limited thereto. For example, the reactive rod-like liquid crystals may include

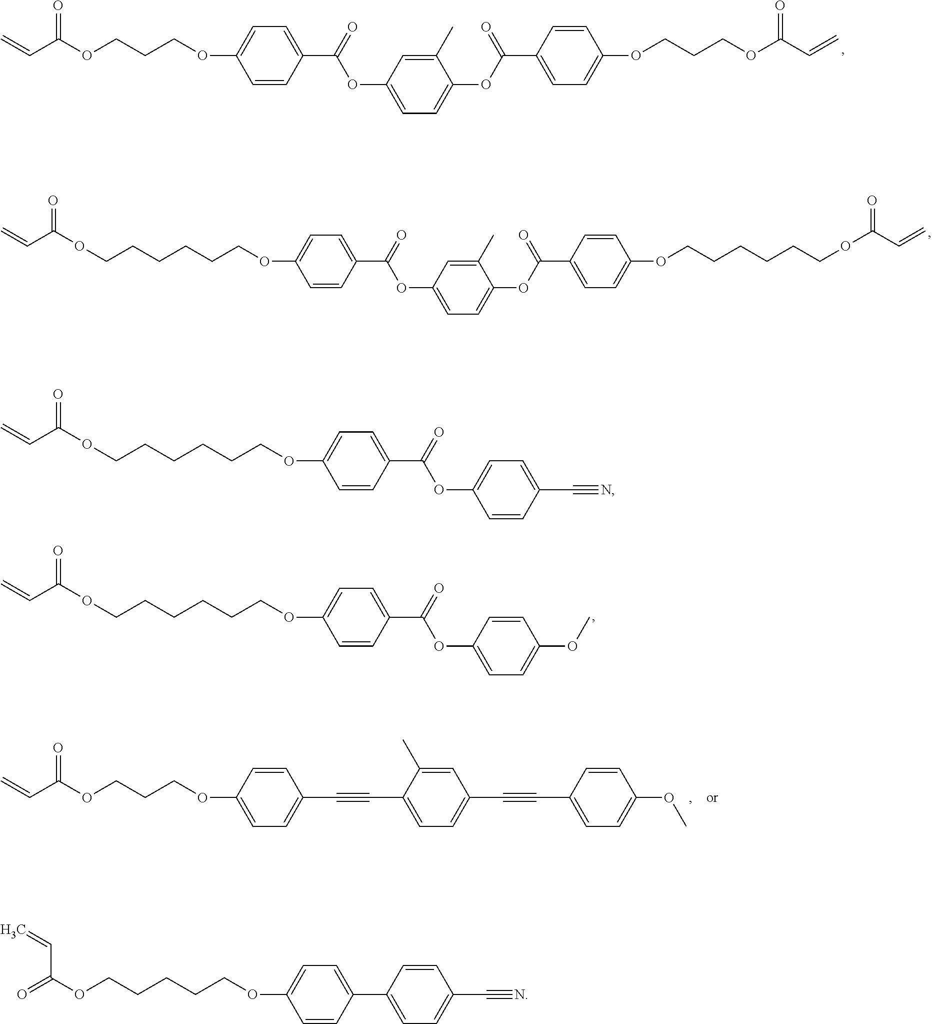

Further, the nematic crystals of the half-wave phase-retardation film and the nematic crystals of the quarter-wave phase-retardation film may be coated by die coating or spin coating, and then be cross-linked and cured to form the half-wave phase-retardation film and the quarter-wave phase-retardation film.

The phase-retardation films mentioned above may be applied to a circular polarizer for manufacturing a wideband circular polarizer. In one embodiment, the wideband circular polarizer may include the linear polarizer and the wideband compound phase-retardation film, and the wideband compound phase-retardation film is disposed on the linear polarizer. As described above, the wideband compound phase-retardation film may include a half-wave phase-retardation film and a quarter-wave phase-retardation film. The material used in the half-wave phase-retardation film has a birefringence Δn₁, and the material used in the quarter-wave phase-retardation film has a birefringence Δn₂. In one embodiment, the birefringence dispersion Δn₁(λ) of the material used in the half-wave phase-retardation film is smaller than the birefringence dispersion Δn₂(λ) of the material used in the quarter-wave phase-retardation film.

In one embodiment, the linear polarizer, the half-wave phase-retardation film and the quarter-wave phase-retardation film of the wideband circular polarizer have uniaxial optical axes. In one embodiment, the linear polarizer is disposed on and in contact with the half-wave phase-retardation film, and a predetermined angular difference of an optical axis of the half-wave phase-retardation film and an absorption axis of the linear polarizer may be from 5 to 30 degrees. In one embodiment, the predetermined angular difference of the optical axis of the half-wave phase-retardation film and the absorption axis of the linear polarizer may be from 10 to 20 degrees.

Similarly, optical axes of the linear polarizer, the half-wave phase-retardation film, and the quarter-wave phase-retardation film according to the embodiment of the disclosure are set different, and these optical axes are not parallel with each other. For example, a predetermined angular difference between the optical axis of the half-wave phase-retardation film and the optical axis of the quarter-wave phase-retardation film may be from 15 to 70 degrees or from 30 to 60 degrees.

In one embodiment, the half-wave phase-retardation film and the quarter-wave phase-retardation film of the wideband compound phase-retardation film are made of different reactive rod-like liquid crystals (RLC) respectively. The different reactive rod-like liquid crystals can be in uniaxial parallel aligned arrangement.

The half-wave phase-retardation film may have a retardance in the range from 200 to 300 nm, such as from 240 to 290 nm at a specified wavelength of 550 nm; the quarter-wave phase-retardation film may have a retardance in the range from 80 to 160 nm, such as from 120 to 160 nm at a specified wavelength of 550 nm.

Here, Abbe refractometer, model: DR-A1 made by ATAGO CO., LTD is used to measure the birefringence dispersion of the phase-retardation film in the examples of the disclosure and the comparative examples; AxoScan MMP made by Axometrics, Inc. is used to measure the retardation dispersion in the examples of the disclosure and the comparative examples.

### Example 1: Compound Phase-Retardation Film—a Combination of Different Liquid Crystal Materials: Low Birefringence Half-Wave Phase-Retardation Film and High Birefringence Quarter-Wave Phase-Retardation Film

BASF LC242 (LC₁, Δn=0.147, solid content: 30%) and BASF LC 1057 (LC₂, Δn=0.203, solid content: 15%) were used and individually dissolved in a 4:1 ratio solvent of toluene/cyclopentanone. Then, photoinitiator (4 wt % of 1-907 initiator made by BASF chemical company) was individually added to provide two bottles of polymerizable nematic liquid crystal solution which were respectively used in the half-wave phase-retardation film and the quarter-wave phase-retardation film. The above prepared solutions were coated on triacetate cellulose (TAC) substrates which had been proceeded 15° and 75° alignment treatment respectively. Then, a prebake process was executed at 90±5° C. to remove the solvent, and an annealing treatment was executed at about 90±5° C. under nitrogen. Finally, UV irradiation for about 60 seconds was exposed to crosslink the above polymerizable nematic liquid crystal. The half-wave phase-retardation film and the quarter-wave phase-retardation film are completed.

### Comparative Example 1: Compound Phase-Retardation Film—a Combination of Same Liquid Crystal Materials: The Half-Wave Phase-Retardation Film and the Quarter-Wave Phase-Retardation Film

BASF LC242 (LC₁, Δn=0.147) having 30% and 20% solid content were used and individually dissolved in a 4:1 ratio solvent of toluene/cyclopentanone. Then, photoinitiator (4 wt % of 1-907 initiator made by BASF chemical company) was individually added to provide two bottles of polymerizable nematic liquid crystal solution which were respectively used in the half-wave phase-retardation film and the quarter-wave phase-retardation film. The above prepared solutions were coated on triacetate cellulose (TAC) substrates which had been proceeded 15° and 75° alignment treatment respectively. Then, a prebake process was executed at 90±5° C. to remove the solvent, and an annealing treatment was executed at about 90±5° C. under nitrogen. Finally, UV irradiation for about 60 seconds was exposed to crosslink the above polymerizable nematic liquid crystal. The half-wave phase-retardation film and the quarter-wave phase-retardation film are completed.

### Comparative Example 2: Compound Phase-Retardation Film—a Combination of Different Liquid Crystal Materials: High Birefringence Half-Wave Phase-Retardation Film and Low Birefringence Quarter-Wave Phase-Retardation Film

BASF LC 1057 (LC₂, Δn=0.203, solid content: 22.5%) and BASF LC242 (LC₁, Δn=0.147, solid content: 30%) and were used and individually dissolved in a 4:1 ratio solvent of toluene/cyclopentanone. Then, photoinitiator (4 wt % of 1-907 initiator made by BASF chemical company) was individually added to provide two bottles of polymerizable nematic liquid crystal solution which were respectively used in the half-wave phase-retardation film and the quarter-wave phase-retardation film. The above prepared solutions were coated on triacetate cellulose (TAC) substrates which had been proceeded 15° and 75° alignment treatment respectively. Then, a prebake process was executed at 90±5° C. to remove the solvent, and an annealing treatment was executed at about 90±5° C. under nitrogen. Finally, UV irradiation for about 60 seconds was exposed to crosslink the above polymerizable nematic liquid crystal. The half-wave phase-retardation film and the quarter-wave phase-retardation film are completed.

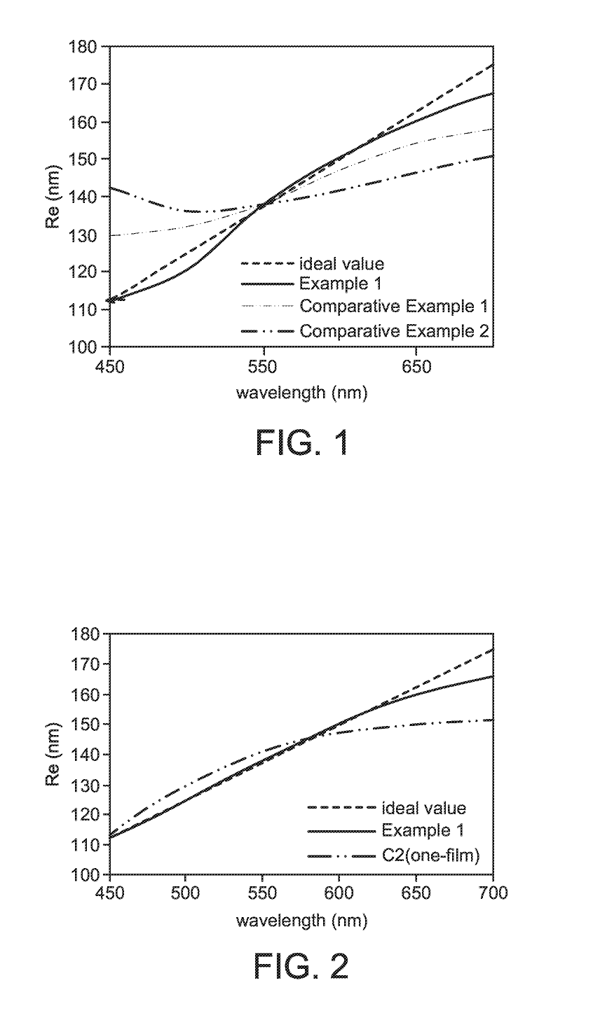

FIG. 1 shows all the retardation dispersion results of Example 1, Comparative Example 1, Comparative Example 2 and ideal wideband retardation dispersion value. As shown in FIG. 1, different liquid crystals used in half-wave phase-retardation film (low birefringence) and the quarter-wave phase-retardation film (high birefringence) in the Example 1 of the disclosure, and the retardation dispersion of Example 1 exhibited very close result to the ideal wideband retardation dispersion value. FIG. 2 shows all the retardation dispersion results of Example 1, a commercial wideband film and ideal wideband retardation dispersion.

As shown in FIG. 2, a combination of different liquid crystals used in half-wave phase-retardation film (low birefringence) and quarter-wave phase-retardation film (high birefringence) in the Example 1 of the disclosure exhibited very close result to the ideal wideband value.

TABLE 1 summarizes the results of retardation dispersion of Example 1, Comparative Example 1, Comparative Example 2, commercial wideband QWP (single film type)(C2) and ideal retardation value at different wavelengths.

TABLE 1

| | | | Comparative | | Comparative | | |
|---|---|---|---|---|---|---|---|
| | Example 1 | | Example 1 | | Example 2 | | |
| Materials | | Δn | | Δn | | Δn | commercial |
| half-wave | LC₁ | low | LC₁ | low | LC₂ | high | |
| phase- | | | | | | | |
| retardation | | | | | | | |
| film | | | | | | | |
| quarter-wave | LC₂ | high | | | LC₁ | low | |
| phase- | | | | | | | |
| retardation | | | | | | | |
| film | | | | | | | |

| | ideal | | | | |
|---|---|---|---|---|---|
| | retardation | | | | |
| wavelength | value(nm) | retardation dispersion (nm) | | | |
| 450 nm | 112.5 | 112.3 | 129.72 | 142.41 | 113 |
| 550 nm | 137.5 | 138 | 138 | 138 | 141 |
| 650 nm | 162.5 | 160 | 154.2 | 146.43 | 150 |
| Standard | | 0.0025 | 0.026 | 0.047 | 0.013 |
| deviation | | | | | |

According to the disclosure, low birefringence half-wave phase-retardation film and high birefringence quarter-wave phase-retardation film show a very close result to that of ideal wideband retardation dispersion. It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A wideband compound phase-retardation film, comprising:
a half-wave phase-retardation film using materials having a birefringence Δn₁, and
a quarter-wave phase-retardation film using materials having a birefringence Δn₂, wherein the quarter-wave phase-retardation film is disposed on the half-wave phase-retardation film;
wherein the birefringence Δn₁ is smaller than the birefringence Δn₂, the materials of the half-wave phase-retardation film and the quarter-wave phase-retardation film are adopted from different reactive rod-like liquid crystals, and a birefringence dispersion of the half-wave phase-retardation film, Δn₁(λ), is smaller than a birefringence dispersion of the quarter-wave phase-retardation film, Δn₂(λ).

2. The wideband compound phase-retardation film according to claim 1, wherein an optical axis of the half-wave phase-retardation film is set different from an optical axis of the quarter-wave phase-retardation film, and a predetermined angular difference between the optical axis of the half-wave phase-retardation film and the optical axis of the quarter-wave phase-retardation film is from 15 to 70 degrees.

3. The wideband compound phase-retardation film according to claim 2, wherein the predetermined angular difference between the optical axis of the half-wave phase-retardation film and the optical axis of the quarter-wave phase-retardation film is from 30 to 60 degrees.

4. The wideband compound phase-retardation film according to claim 1, wherein the half-wave phase-retardation film has a retardance in the range from 240 to 290 nm at a specified wavelength of 550 nm.

5. The wideband compound phase-retardation film according to claim 1, wherein the quarter-wave phase-retardation film has a retardance in the range from 120 to 160 nm at a specified wavelength of 550 nm.

6. The wideband compound phase-retardation film according to claim 1, wherein the half-wave phase-retardation film and the quarter-wave phase-retardation film are made of different reactive rod-like liquid crystals respectively, and the different reactive rod-like liquid crystals are in uniaxial parallel aligned arrangement.

7. The wideband compound phase-retardation film according to claim 1, wherein a difference between the birefringence dispersion Δn1(λ) and the birefringence dispersion Δn2(λ) is larger than or equal to 0.02.

8. The wideband compound phase-retardation film according to claim 1, wherein the reactive rod-like liquid crystals comprise:

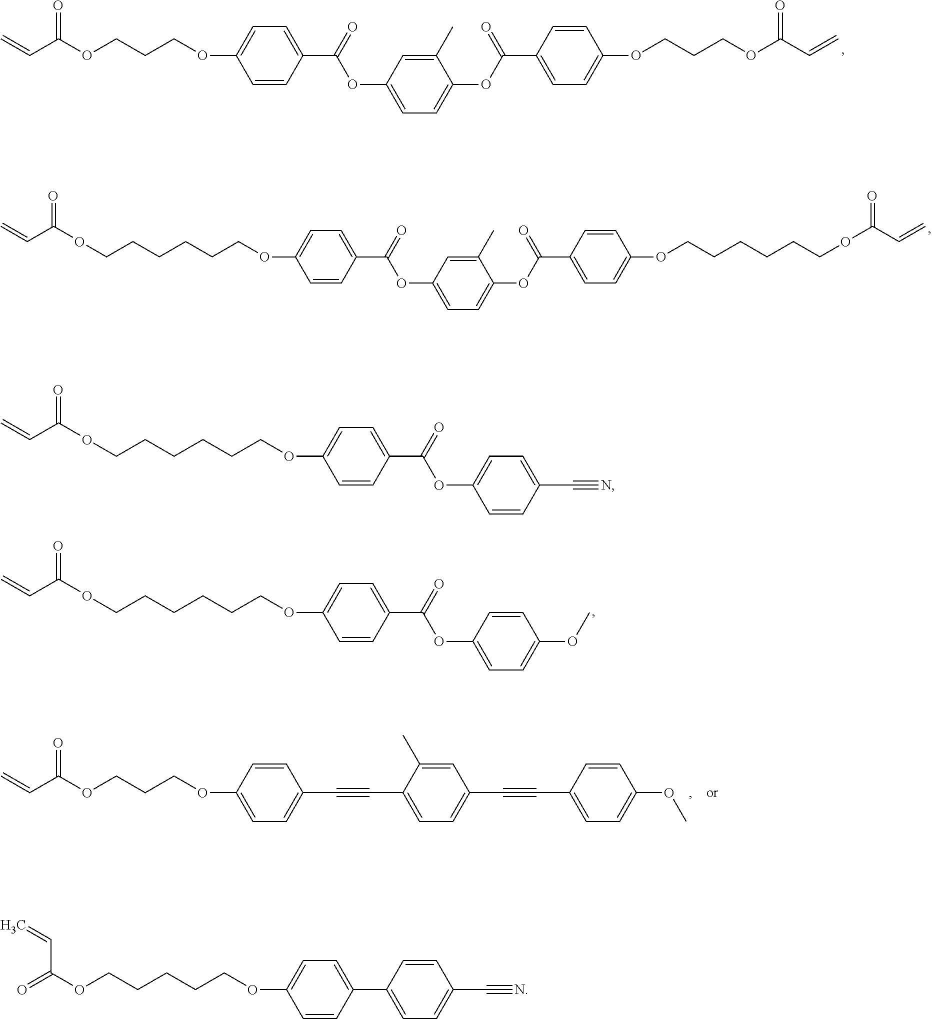

9. A wideband circular polarizer, comprising:
a linear polarizer; and
a wideband compound phase-retardation film disposed on the linear polarizer, comprising:
a half-wave phase-retardation film using materials having a birefringence Δn₁, and
a quarter-wave phase-retardation film using materials having a birefringence Δn₂, wherein the quarter-wave phase-retardation film is disposed on the half-wave phase-retardation film;
wherein the birefringence Δn₁ is smaller than the birefringence Δn₂, the materials of the half-wave phase-retardation film and the quarter-wave phase-retardation film are adopted from different reactive rod-like liquid crystals, and a birefringence dispersion of the half-wave phase-retardation film, Δn₁(λ), is smaller than a birefringence dispersion of the quarter-wave phase-retardation film, Δn₂(λ).

10. The wideband circular polarizer according to claim 9, wherein the linear polarizer is disposed on and in contact with the half-wave phase-retardation film, and a predetermined angular difference between the optical axis of the half-wave phase-retardation film and an absorption axis of the linear polarizer is from 5 to 30 degrees.

11. The wideband circular polarizer according to claim 9, wherein the linear polarizer is disposed on and in contact with the half-wave phase-retardation film, and a predetermined angular difference between the optical axis of the half-wave phase-retardation film and an absorption axis of the linear polarizer is from 10 to 20 degrees.

12. The wideband circular polarizer according to claim 9, wherein optical axes of the linear polarizer, the half-wave phase-retardation film, and the of the quarter-wave phase-retardation film are different and not parallel with each other.

13. The wideband circular polarizer according to claim 12, wherein a predetermined angular difference between the optical axis of the half-wave phase-retardation film and the optical axis of the quarter-wave phase-retardation film is from 15 to 70 degrees.

14. The wideband circular polarizer according to claim 12, wherein a predetermined angular difference between the optical axis of the half-wave phase-retardation film and the optical axis of the quarter-wave phase-retardation film is from 30 to 60 degrees.

15. The wideband circular polarizer according to claim 9, wherein the half-wave phase-retardation film has a retardance in the range from 240 to 290 nm at a specified wavelength of 550 nm.

16. The wideband circular polarizer according to claim 9, wherein the quarter-wave phase-retardation film has a retardance in the range from 120 to 160 nm at a specified wavelength of 550 nm.

17. The wideband circular polarizer according to claim 9, wherein the half-wave phase-retardation film and the quarter-wave phase-retardation film are made of different reactive rod-like liquid crystals respectively, and the different reactive rod-like liquid crystals are in uniaxial parallel aligned arrangement.

18. The wideband circular polarizer according to claim 9, wherein a difference between the birefringence dispersion Δn1(λ) and the birefringence dispersion Δn2(λ) is larger than or equal to 0.02.

19. The wideband circular polarizer according to claim 9, wherein the reactive rod-like liquid crystals are [chemical structure]
